(19) United States
(12) Patent Application Publication
(10) Pub. No.: US 2026/0102873 A1
(43) Pub. Date: Apr. 16, 2026

(54) TILE TOOL NUT

(71) Applicant: Crowne Tools LLC, Dallas, TX (US)

(72) Inventor: Andrew Eylander, Carlsbad, CA (US)

(21) Appl. No.: 19/421,950

(22) Filed: Dec. 16, 2025

Related U.S. Application Data
(63) Continuation-in-part of application No. 18/198,413, filed on May 17, 2023.
(60) Provisional application No. 63/343,031, filed on May 17, 2022.

(51) Int. Cl. B24B 45/00; B24B 27/08; F16B 23/00

(52) U.S. Cl. CPC B24B 45/00; F16B 23/00; B24B 27/08

(57) ABSTRACT

A tool nut includes a frustoconical nut body that defines a central longitudinal axis of rotation, the frustoconical nut body comprising a top surface that defines a first diameter and a bottom surface that defines a second diameter, the second diameter greater than the first diameter, the bottom surface comprises a contiguous flat surface transverse to the central longitudinal axis of rotation; a threaded passage through the frustoconical nut body along the central longitudinal axis of rotation, the threaded passage operable to thread onto a spindle of a cutting tool; a counterbore in the bottom surface along the central longitudinal axis of rotation; a first mounting feature through the frustoconical nut body along a first axis parallel to the central longitudinal axis of rotation; and a second mounting feature through the frustoconical nut body along a second axis parallel to the central longitudinal axis of rotation, the central longitudinal axis of rotation, the first axis, and the second axis, along a common line.

### CROSS REFERENCE TO RELATED APPLICATION[S]

This application claims the priority as a continuation-in-part of U.S. Nonprovisional patent application Ser. No. 18/198,413 (01NOA03-01212-CRO) filed May 17, 2023 which claims priority to U.S. Provisional Patent Application Ser. No. 63/343,031 filed May 17, 2022, entitled “TILE TOOL.”

Each of the aforementioned patent applications, and any applications related thereto, are herein incorporated by reference in their entirety.

### BACKGROUND

The present disclosure relates to tools, and more specifically to a threaded nut that is used to connect a diamond tile blade, polishing pad, flap disc or any other blade disc to a tool such as an angle grinder.

Many tile projects require cuts, at various angles, with common cutting tools. For most tile applications, the blade is a circular diamond disc/blade bound to the angle grinder with a nut. The nut is commonly made of steel and the grinder itself is designed for metal fabrication applications, floor grinding or polishing.

The nut commonly used to connect the blade to the grinder tends to leave a streak or mark when the standard steel nut contacts the material, specifically wood, tile or stone as a cut is made. Often referred to as a “metal burn” the steel spinning at such a high rate will mar the material. In addition, in certain cases, for example, tile will chip when the nut contacts the tile. This is particularly common when angled or beveled cuts are necessary. One such conventional nut 105 and associated burn 110 on the tile, is illustrated in FIG. 1, labeled as “prior art.”

This background section is intended to introduce the reader to various aspects of art that may be related to various aspects of the present disclosure, which are described and/or claimed below. This discussion is believed to assist the reader with background information to facilitate a better understanding of the various aspects of the present disclosure. Accordingly, it should be understood that these statements are to be read in this light, and not as admissions of prior art.

### SUMMARY

A tool nut according to one disclosed non-limiting embodiment of the present disclosure includes a frustoconical nut body that defines a central longitudinal axis of rotation, the frustoconical nut body comprising a top surface that defines a first diameter and a bottom surface that defines a second diameter, the second diameter greater than the first diameter, the bottom surface comprises a contiguous flat surface transverse to the central longitudinal axis of rotation; a threaded passage through the frustoconical nut body along the central longitudinal axis of rotation, the threaded passage operable to thread onto a spindle of a cutting tool; a counterbore in the bottom surface along the central longitudinal axis of rotation; a first mounting feature through the frustoconical nut body along a first axis parallel to the central longitudinal axis of rotation; and a second mounting feature through the frustoconical nut body along a second axis parallel to the central longitudinal axis of rotation, the central longitudinal axis of rotation, the first axis, and the second axis, along a common line.

A further embodiment of any of the foregoing embodiments of the present disclosure includes that the bottom surface of the tool nut is configured to fit against a blade associated with a cutting tool.

A further embodiment of any of the foregoing embodiments of the present disclosure includes that the bottom surface of the tool nut is configured to fit flush against a blade associated with a cutting tool.

A further embodiment of any of the foregoing embodiments of the present disclosure includes that the frustoconical nut body is manufactured of a non-metallic material.

A further embodiment of any of the foregoing embodiments of the present disclosure includes that the frustoconical nut body is manufactured of a single seamless piece.

A further embodiment of any of the foregoing embodiments of the present disclosure includes that the frustoconical nut body is milled.

A further embodiment of any of the foregoing embodiments of the present disclosure includes that the frustoconical nut body is manufactured to withstand rotation about the central longitudinal axis of rotation up to 20,000 RPMs.

A further embodiment of any of the foregoing embodiments of the present disclosure includes that the bottom surface of the tool nut is between 2-3 inches in diameter and a height of the tool nut along the central longitudinal axis of rotation is less than 0.5 inches.

A further embodiment of any of the foregoing embodiments of the present disclosure includes that the first and second mounting feature is a hole.

A further embodiment of any of the foregoing embodiments of the present disclosure includes that the first and second mounting feature is an indentation.

A further embodiment of any of the foregoing embodiments of the present disclosure includes that the first and second mounting feature is racetrack shaped.

A tool nut according to one disclosed non-limiting embodiment of the present disclosure includes a frustoconical nut body that defines a central longitudinal axis of rotation, the frustoconical nut body comprising a top surface that defines a first diameter and a bottom surface that defines a second diameter, the second diameter greater than the first diameter, the bottom surface comprises a contiguous flat surface transverse to the central longitudinal axis of rotation; a threaded passage through the frustoconical nut body along the central longitudinal axis of rotation, the threaded passage operable to thread onto a spindle of a cutting tool; a chamfer in the bottom surface along the central longitudinal axis of rotation; a first mounting feature through the frustoconical nut body along a first axis parallel to the central longitudinal axis of rotation; and a second mounting feature through the frustoconical nut body along a second axis parallel to the central longitudinal axis of rotation, the central longitudinal axis of rotation, the first axis, and the second axis, along a common line.

A further embodiment of any of the foregoing embodiments of the present disclosure includes that the bottom surface of the tool nut is configured to fit flush against a grinder associated with a cutting tool.

A further embodiment of any of the foregoing embodiments of the present disclosure includes that the bottom surface of the tool nut is configured to fit flush against a blade associated with a cutting tool.

A further embodiment of any of the foregoing embodiments of the present disclosure includes that the frustoconical nut body is manufactured of a non-metallic material.

A further embodiment of any of the foregoing embodiments of the present disclosure includes that the frustoconical nut body is manufactured of a single seamless piece.

A further embodiment of any of the foregoing embodiments of the present disclosure includes that the frustoconical nut body is milled.

A further embodiment of any of the foregoing embodiments of the present disclosure includes that the frustoconical nut body is manufactured to withstand rotation about the central longitudinal axis of rotation up to 20,000 RPMs.

A further embodiment of any of the foregoing embodiments of the present disclosure includes that the bottom surface of the tool nut is between 2-3 inches in diameter and a height of the tool nut along the central longitudinal axis of rotation is less than 0.5 inches.

A further embodiment of any of the foregoing embodiments of the present disclosure includes that the frustoconical nut body is manufactured of a single seamless piece of acetol.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 depicts a PRIOR ART nut.

FIG. 2A depicts a top perspective view of a non-marking impact resistant nut, according to one disclosed non-limiting embodiment.

FIG. 2B depicts a top view of a non-marking impact resistant nut, according to one disclosed non-limiting embodiment.

FIG. 2C depicts a side view of a non-marking impact resistant nut, according to one disclosed non-limiting embodiment.

FIG. 2D depicts a bottom perspective view of a non-marking impact resistant tool nut according to one disclosed non-limiting embodiment.

FIG. 2E depicts a bottom view of a non-marking impact resistant nut, according to one disclosed non-limiting embodiment.

FIG. 3 depicts a non-marking impact resistant tool nut engaged to a tile grinder, according to one disclosed non-limiting embodiment.

FIG. 4A depicts bottom view of another embodiment of a non-marking impact resistant tool nut according to one disclosed non-limiting embodiment.

FIG. 4B depicts a side view of another embodiment of a non-marking impact resistant nut, according to one disclosed non-limiting embodiment.

FIG. 5 depicts steps associated with a method for cutting tile, in accordance with the disclosed embodiments.

FIG. 6 depicts a top perspective view of a non-marking impact resistant nut, according to another disclosed non-limiting embodiment.

### DETAILED DESCRIPTION

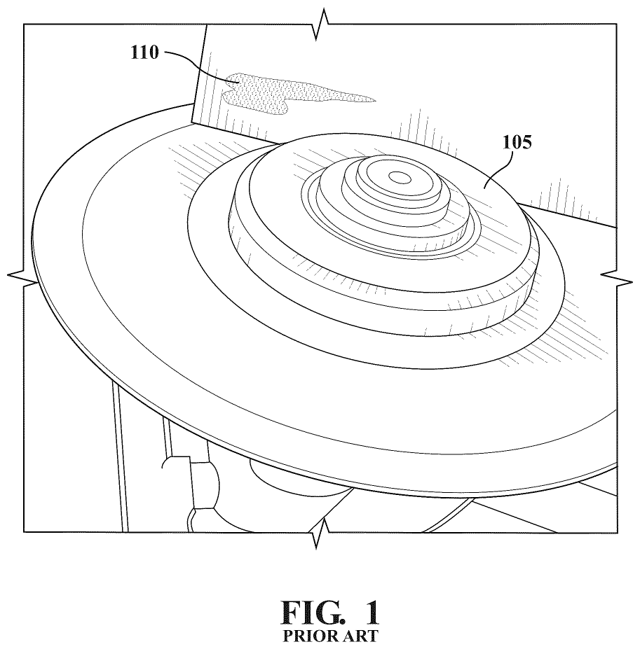

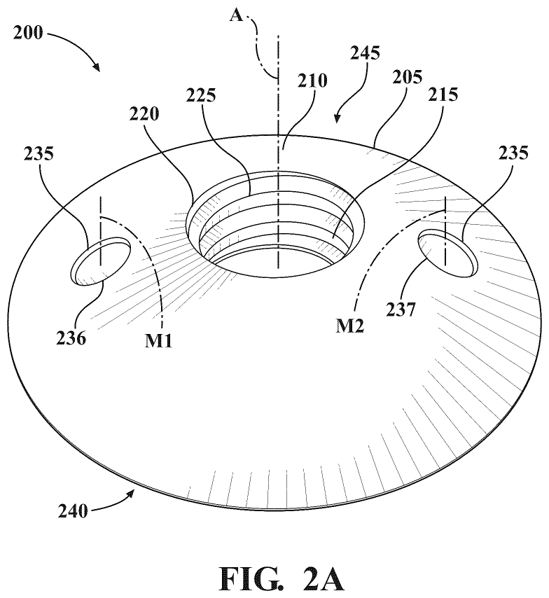

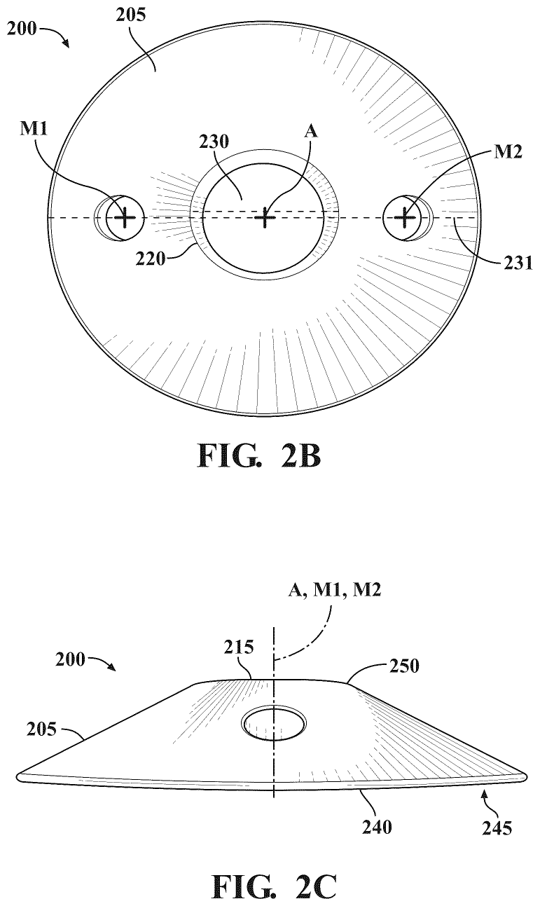

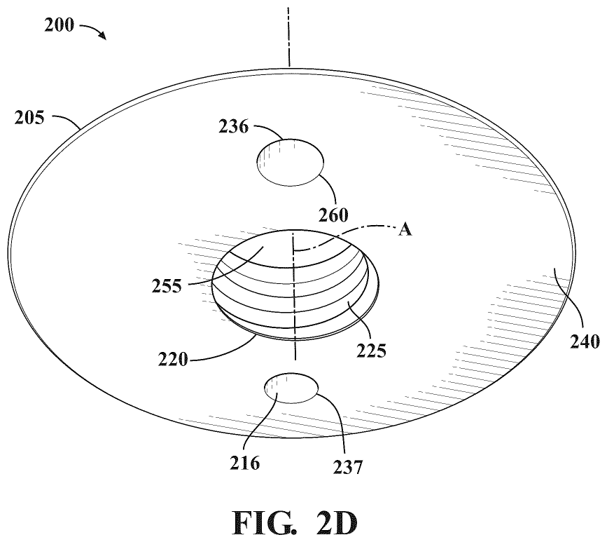

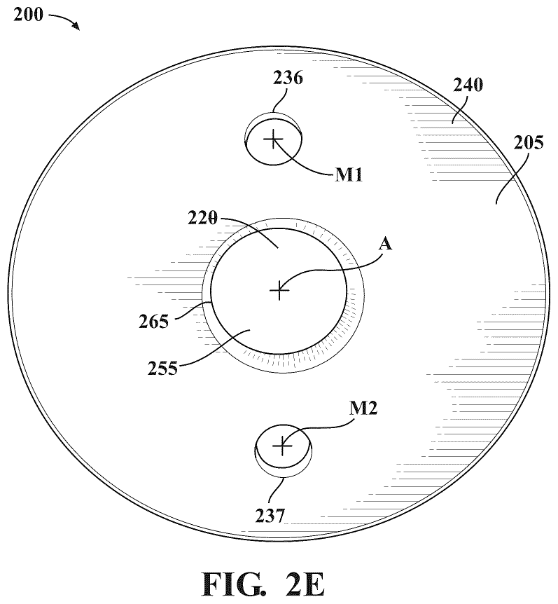

In embodiments, a non-marking impact resistant tool nut 200, (also referred to as a locking flange), is illustrated in FIG. 2-4. The non-marking impact resistant tool nut 200 prevents tile damage during the cutting process with a grinder, saw, or other such tool. The non-marking impact resistant tool nut will not chip the work piece (e.g., tile) during a miter cut, nor mark/mar the tile, as compared to a standard nut, as illustrated in FIG. 1, which often leaves a burn 110 in the tile surface that often cannot be removed.

The non-marking impact resistant tool nut 200 generally comprises a frustro-conical body that glances off the edge or surface of tile without chipping or marring them. This non-marking impact resistant tool nut can be made of a non-marking, machinable plastic or other such material. In certain embodiments, for example, a non-metallic material such as acetol which is sufficiently soft to avoid chipping but also sufficiently strong to securely affix the grinder blade or saw blade to the saw. In other embodiments, other materials can be used, provided such materials do not leave marks on the tile.

In certain embodiments, the non-marking impact resistant tool nut can be manufactured from a single solid piece of material such as by milling so that there are no seams along the nut body that may compromise the integrity of the non-marking impact resistant tool nut during use. The integral nut body is design to withstand the high speeds of a grinder running at up to 20,000 RPMs.

FIG. 2A depicts a top perspective view of the non-marking impact resistant tool nut 200, in accordance with the disclosed embodiments. As illustrated in FIG. 2A, the non-marking impact resistant tool nut 200 can comprise a frustoconical nut body 205 with a generally coned shape 10 tapering from a center 15, of the nut body 205, to a larger outer diameter 245 about a central rotational axis A.

The center 15 of the coned shaped body 205 can include a threaded passage 220 with female threading 225. The diameter 230 of threaded passage 220 and dimensions of the thread 225 therein are selected to match one of various grinder tools. It should be appreciated that most grinders or tile saws have a standard size spindle. The dimensions of the threaded passage 220 and thread 225 can be selected to match standard spindle dimensions.

The cone shaped body 205 can further include a pair of mounting features 235, such as a a first mounting feature 236 along an axis M1 and second mounting feature 237 along an axis M2, formed on either side of the threaded passage 220. The axes A, M1, and M2 are parallel. The axes A, M1, and M2 are also along a common line.

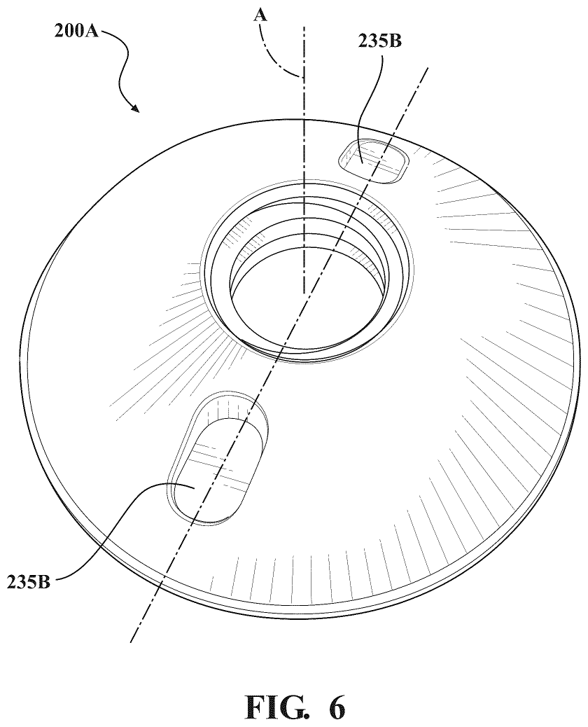

The mounting features 235 can be of various configurations such as a circular holes 235A, (FIG. 2A-2D) racetrack shaped recesses 235B (FIG. 6), and/or various other indentations, openings, holes, apertures, etc., formed in the nut body 205, that are configured to facilitate the application of torque to secure the non-marking impact resistant tool nut 200 to the spindle of a grinder, or other such cutting tool via a tool that applies torque through engagement with the mounting features 235.

The bottom surface 240 of the non-marking impact resistant tool nut 200 can be configured to be substantially flat and circular so that it can properly secure against the grinder wheel or saw blade.

In practice, the non-marking impact resistant tool nut 200 (or flange) can be used in conjunction with a backing flange, also known as an inner flange. The backing flange can fit onto the spindle of the grinder behind the grinding wheel. The grinder spindle can include male threads which match the female threads 225 on the threaded passage 220 of the non-marking impact resistant tool nut 200. With the backing flange in place, the grinding wheel (or other circular cutting tool) can be installed over the backing flange on the spindle. The non-marking impact resistant tool nut 200 can then be positioned on the exterior facing side of the grinding wheel, with the flat side of the non-marking impact resistant tool nut 200 securely against the grinding wheel. This can be accomplished by engaging the non-marking impact resistant tool nut 200 threads 225 to the spindle threads, and tightening the nut 200 with the mounting features 235.

FIG. 2B depicts a top view of a non-marking impact resistant tool nut 200, in accordance with the disclosed embodiments. As illustrated in FIG. 2B, the diameter 230 of the threaded passage 220, is smaller than that of the outer perimeter 245.

FIG. 2C depicts an elevation view of a non-marking impact resistant tool nut 200 in accordance with the disclosed embodiments. In this view, the tapering from the center 15, of the nut body 205, to the outer perimeter 245. As illustrated, the top 250 of the nut body 205 can be flattened. This view further illustrates that the bottom surface 240 of the nut body 205 can be a contiguous flat surface.

FIG. 2D depicts a bottom perspective view of a non-marking impact resistant tool nut 200, in accordance with the disclosed embodiments. This view illustrates the arrangement of the bottom opening 255 associated with the threaded passage 220. The first mounting feature 236 further includes bottom opening 260, and the second mounting feature 237 has bottom opening 261.

FIG. 2E depicts a bottom view of a non-marking impact resistant tool nut 200, in accordance with the disclosed embodiments. As illustrated in FIG. 2E, the threaded passage 220 is configured in line with the first mounting feature 236 and second mounting feature 237. In certain embodiments, the bottom opening 255 can include chamfer 265.

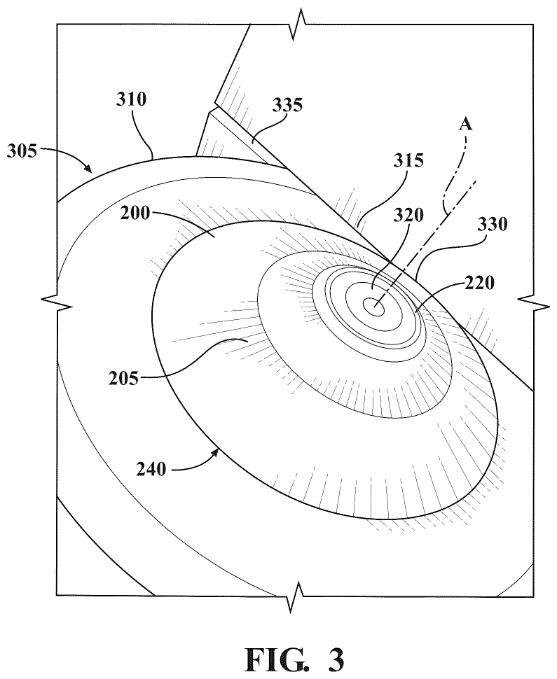

FIG. 3 depicts a non-marking impact resistant tool nut 200 engaged to a cutting tool 305, in accordance with the disclosed embodiments. For example, in an embodiment the non-marking impact resistant tool nut 200, or locking flange, can be affixed to a grinding wheel 310 associated with a cutting tool 305 such as a tile grinder. The grinding wheel 310 can be used to cut a tile or other such material, such as tile 315.

The non-marking impact resistant tool nut 200 is configured to engage the male threads of a spindle 320. The nut 200 is configured such that the bottom surface 240 mounts flush to the cutting tool 305. The depth of the nut 200 can be selected such that the nut 200 is secured on the spindle 320, but also so that the spindle 320 does not extend beyond the threaded passage 220 of the nut 200. In other embodiments, it is acceptable for the spindle to extend beyond the threaded passage 220.

As illustrated in FIG. 3, the non-marking impact resistant tool nut 200 can contact the tile 315 at the contact point 330, as a cut 335 is made in the tile 315, without leaving any burn or mark on the tile 315. Likewise, the non-marking impact resistant tool nut 200 does not chip or damage the tile 315 as it is cut.

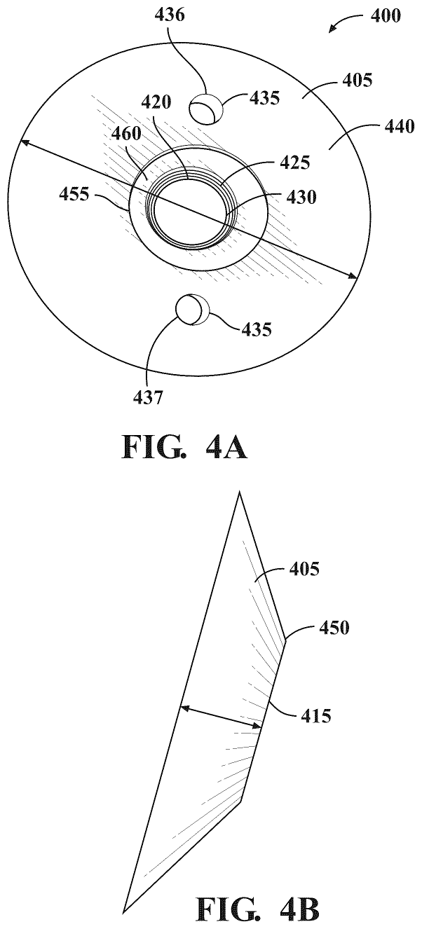

FIGS. 4A and 4B illustrate aspects of another embodiment of a non-marking impact resistant tool nut 400, in accordance with the disclosed embodiments. The non-marking impact resistant tool nut 400 can include some or all of the aspects illustrated in FIGS. 2A-E and FIG. 3. In this embodiment, the bottom surface of the tool nut is between 2-3 inches in diameter and a height of the tool nut along the central longitudinal A of rotation may be, for example, less than 0.5 inches.

The non-marking impact resistant tool nut 400 can comprise a nut body 405 with a generally coned shape 410 tapering from the center 415, of the nut body 405, to a larger diameter outer perimeter 445.

The center 415 of the coned shaped body 405 can include a tubular channel 420 with female threading 425. The diameter 430 of the tubular channel 420 and dimensions of the threading 425 can be selected to match one of various grinder models. It should be appreciated that most grinders have a standard size spindle. The dimensions of the tubular channel 420 and threading 425 can be selected to match standard spindle dimensions.

The cone shaped body 405 can further include a pair of mounting features 435, first mounting feature 436 and second mounting feature 437, formed axially from one another on either side of the central tubular channel 420. The mounting features 435 can be circular tubes formed in the nut body 405, and are configured to aid in the application of torque to secure the non-marking impact resistant tool nut 400 to the spindle of a grinder, or other such cutting tool. The bottom surface 440 of the non-marking impact resistant tool nut 400 can be configured to be substantially flat to be secure against the grinder wheel.

In practice, the non-marking impact resistant tool nut 400 can be used in conjunction with a backing flange, also known as an inner flange. The backing flange can fit onto the spindle of the grinder behind the grinding wheel. The grinder spindle can include male threads which match the female threads on the tubular channel 420 of the non-marking impact resistant tool nut 400. With the backing flange in place, the grinding wheel (or other circular cutting tool) can be installed over the backing flange on the spindle. The non-marking impact resistant tool nut 400 can then be positioned on the exterior facing side of the grinding wheel, with the flat side of the non-marking impact resistant tool nut 400 securely against the grinding wheel. This can be accomplished by engaging the non-marking impact resistant tool nut 400 threads to the spindle threads, and tightening the nut 400 with the mounting features 435.

The cone shaped body 405 is configured such that the top 450 is flattened. A center tubular channel 420 can include female threading 425. Two mounting features 435 can be formed across from one another, and equidistant from the tubular channel 420. As illustrated, the flat bottom surface 440 can include a counterbore 455 formed by a circular recess 460 about the center tubular channel 420.

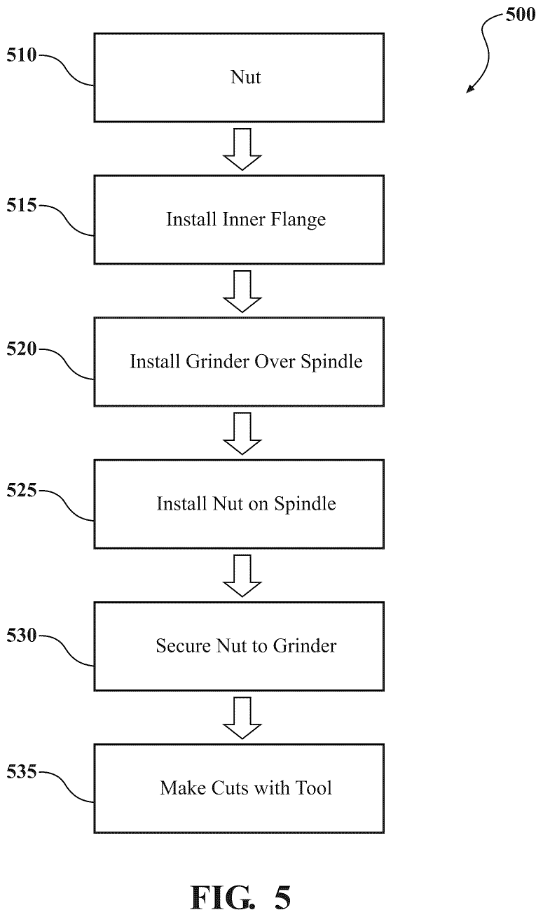

FIG. 5 illustrates a flow chart of steps associated with a method 500 for cutting a tile with a non-marking impact resistant tool nut 200, 200A or 400 (step 510).

Next, an inner flange can be installed on the spindle of the cutting tool (e.g., a grinder) (step 515). With the inner flange installed, the grinder or other such cutting blade can be installed on the spindle (step 520).

At step 525, the non-marking impact resistant tool nut can then be secured to the grinder with the flat side facing the grinder. The non-marking impact resistant tool nut can be tightened against the grinder with the mounting features and a pronged tool designed to impart torque to the non-marking impact resistant tool nut (step 530). The mounting features are important for this purpose since they allow the application of sufficient torque to secure the nut to the grinder.

Once the non-marking impact resistant tool nut is installed on the grinder, at step 535 the tool can be used to cut tile or other such materials. When the non-marking impact resistant tool nut touches the material being cut, it will not chip or mark the material.

With reference to FIG. 6, in another embodiment, a non-marking impact resistant tool nut 200A includes two racetrack shaped recesses 235B arranged along a common line M3 transverse to the central longitudinal axis A. That is, the long axes of each racetrack shaped recesses 235B are along the common line M3 that passes through the central longitudinal axis A. Each racetrack shaped recesses 235B is located generally equidistant between the central longitudinal A and an outer diameter of the non-marking impact resistant tool nut 200A and do not extend through the bottom surface thereof. By not extending through the bottom surface, a larger surface area is provided. In some embodiments, the outer perimeter include a lip that extends from the conical body.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed:

1. A tool nut comprising:
a frustoconical nut body that defines a central longitudinal axis of rotation, the frustoconical nut body comprising a top surface that defines a first diameter and a bottom surface that defines a second diameter, the second diameter greater than the first diameter, the bottom surface comprises a contiguous flat surface transverse to the central longitudinal axis of rotation;
a threaded passage through the frustoconical nut body along the central longitudinal axis of rotation, the threaded passage operable to thread onto a spindle of a cutting tool;
a counterbore in the bottom surface along the central longitudinal axis of rotation;
a first mounting feature through the frustoconical nut body along a first axis parallel to the central longitudinal axis of rotation; and
a second mounting feature through the frustoconical nut body along a second axis parallel to the central longitudinal axis of rotation, the central longitudinal axis of rotation, the first axis, and the second axis, along a common line.

2. The tool nut as recited in claim 1, wherein the bottom surface of the tool nut is configured to fit against a blade associated with a cutting tool.

3. The tool nut as recited in claim 1, wherein the bottom surface of the tool nut is configured to fit flush against a blade associated with a cutting tool.

4. The tool nut as recited in claim 1, wherein the frustoconical nut body is manufactured a non-metallic material.

5. The tool nut as recited in claim 4, wherein the frustoconical nut body is manufactured a single seamless piece.

6. The tool nut as recited in claim 5, wherein the frustoconical nut body is milled.

7. The tool nut as recited in claim 6, wherein the frustoconical nut body is manufactured to withstand rotation about the central longitudinal axis of rotation up to 20,000 RPMs.

8. The tool nut as recited in claim 1, wherein the bottom surface of the tool nut is between 2-3 inches in diameter and a height of the tool nut along the central longitudinal axis of rotation is less than 0.5 inches.

9. The tool nut as recited in claim 1, wherein the first and second mounting feature is a hole.

10. The tool nut as recited in claim 1, wherein the first and second mounting feature is an indentation.

11. The tool nut as recited in claim 1, wherein the first and second mounting feature is racetrack shaped.

12. A tool nut comprising:
a frustoconical nut body that defines a central longitudinal axis of rotation, the frustoconical nut body comprising a top surface that defines a first diameter and a bottom surface that defines a second diameter, the second diameter greater than the first diameter, the bottom surface comprises a contiguous flat surface transverse to the central longitudinal axis of rotation;
a threaded passage through the frustoconical nut body along the central longitudinal axis of rotation, the threaded passage operable to thread onto a spindle of a cutting tool;
a chamfer in the bottom surface along the central longitudinal axis of rotation;
a first mounting feature through the frustoconical nut body along a first axis parallel to the central longitudinal axis of rotation; and
a second mounting feature through the frustoconical nut body along a second axis parallel to the central longitudinal axis of rotation, the central longitudinal axis of rotation, the first axis, and the second axis, along a common line.

13. The tool nut as recited in claim 12, wherein the bottom surface of the tool nut is configured to fit flush against a grinder associated with a cutting tool.

14. The tool nut as recited in claim 12, wherein the bottom surface of the tool nut is configured to fit flush against a blade associated with a cutting tool.

15. The tool nut as recited in claim 12, wherein the frustoconical nut body is manufactured of a non-metallic material.

16. The tool nut as recited in claim 15, wherein the frustoconical nut body is manufactured of a single seamless piece.

17. The tool nut as recited in claim 16, wherein the frustoconical nut body is milled.

18. The tool nut as recited in claim 17, wherein the frustoconical nut body is manufactured to withstand rotation about the central longitudinal axis of rotation up to 20,000 RPMs.

19. The tool nut as recited in claim 18, wherein the bottom surface of the tool nut is between 2-3 inches in diameter and a height of the tool nut along the central longitudinal axis of rotation is less than 0.5 inches.

20. The tool nut as recited in claim 19, wherein the frustoconical nut body is manufactured of a single seamless piece of acetol.
